(19) United States
(12) Patent Application Publication
(10) Pub. No.: US 2014/0010330 A1
(43) Pub. Date: Jan. 9, 2014

(54) TRANSMISSION DEVICE AND TRANSMISSION METHOD

(71) Applicant: FUJITSU LIMITED, Kawasaki-shi (JP)

(72) Inventors: YOSHINOBU SHIZAWA, Yokohama (JP); Hiroaki Maeda, Yokohama (JP); Yousuke Okazaki, Kawasaki (JP); Hirotake Honda, Yokohama (JP)

(21) Appl. No.: 13/922,914

(22) Filed: Jun. 20, 2013

(30) Foreign Application Priority Data
Jul. 9, 2012 (JP) 2012-153971

(51) Int. Cl. H04B 1/04

(52) U.S. Cl. CPC H04B 1/0475
USPC 375/296

(57) ABSTRACT

A transmission device includes a first amplifier, a second amplifier, and a digital signal processor configured to calculate first distortion compensation coefficients based on a first amplified signal obtained by amplifying an input signal by the first amplifier, set a first distortion compensation coefficient reference range used to perform distortion compensation on the input signal based on power of the input signal and the first distortion compensation coefficients, calculate second distortion compensation coefficients based on a second amplified signal obtained by amplifying the input signal by the second amplifier, set a second distortion compensation coefficient reference range used to perform distortion compensation on the input signal based on the power of the input signal and the second distortion compensation coefficients, and calculate a correction coefficient for correcting the second compensation coefficients based on the first distortion compensation coefficient reference range and the second distortion compensation coefficient reference range.

### CROSS-REFERENCE TO RELATED APPLICATION

This application is based upon and claims the benefit of priority of Japanese Patent Application No. 2012-153971 filed on Jul. 9, 2012, the entire contents of which are incorporated herein by reference.

### FIELD

An aspect of this disclosure relates to a radio communication apparatus.

### BACKGROUND

An amplifier used for a radio communication system preferably has highly-linear amplification characteristics (input-output characteristics) to prevent degradation of radio signal spectral characteristics and degradation of transmission characteristics resulting from signal distortion. Also, an amplifier used for a radio communication system preferably has high power efficiency. There exists an amplifier that includes a distortion compensation function to achieve both the linearity and the power efficiency that are mutually incompatible.

There is a distortion compensation method called a predistortion method. In the predistortion method, an input signal to an amplifier is multiplied by a distortion compensation coefficient. That is, a characteristic that is opposite to a distortion characteristic of the amplifier is added beforehand to the input signal so that the amplifier can output a signal with reduced distortion.

A GaN (gallium nitride) device including GaN as a material is becoming widely used as a high-power and highly-efficient amplifier for, for example, a base station in a radio communication system.

A GaN device has a wide band gap and high mobility and provides high-frequency and high-power characteristics that cannot be achieved by laterally-diffused metal oxide semiconductor (LDMOS) and gallium arsenide (GaAs) devices.

Hot-carrier degradation of a metal-oxide semiconductor field-effect transistor (MOSFET) is a phenomenon where hot carriers are injected into and accumulated in a gate oxide film and thereby cause the drain bias current (Idq) to decrease. The hot-carrier degradation causes the current to change gradually or slowly in a relatively long response time.

Meanwhile, for a GaN device, there is a phenomenon called Idq drift. The Idq drift is a phenomenon where Idq decreases when the level of an input high radio frequency (RF) signal decreases. In other words, the Idq drift of a GaN device is a phenomenon where Idq decreases due to carriers trapped at the impurity level in a semiconductor. The Idq drift causes the current to change in a relatively short response time, and the amount of change varies greatly depending on operating conditions such as the radio signal intensity and the environmental temperature. For this reason, in the case of a GaN device, it is preferable to repeatedly update the distortion compensation coefficient at every moment while radio communications are being performed by a communication apparatus to optimize the distortion compensation coefficient.

FIG. 1 illustrates time variation of Ids of a GaN device that is observed when an instantaneous high-intensity signal is input. Ids is a current that flows between the drain and the source. Before the radio signal is input, Ids is at a preset value. After the radio signal is input, Ids decreases greatly and then returns to the preset value as time passes. As Ids changes, the gain of the GaN device also changes. In an operation of an apparatus such as a base station including a combination of an amplifier circuit and a distortion compensation circuit, such changes in characteristics may, for example, degrade the distortion compensation performance and complicate calculations for distortion compensation.

When the Idq drift occurs and input-output characteristics of an amplifier changes, a distortion compensation circuit performs calculations to optimize the distortion compensation coefficient. However, when a change caused by the Idq drift is large, it takes time until the calculations of the distortion compensation coefficient come to an end and the power leakage to an adjacent channel becomes large during the calculations.

Here, Japanese Laid-Open Patent Publication No. 11-45923, for example, discloses a semiconductor device that measures a temperature using a monitoring element and corrects circuit characteristics using a correction table.

There also exists a circuit that performs distortion compensation using a combination of an RF amplification GaN device and a monitoring GaN device to prevent problems caused by the Idq drift such as degradation of distortion compensation characteristics and an increase in time necessary to obtain a desired distortion compensation coefficient.

However, with the circuit that performs distortion compensation using a combination of an RF amplification GaN device and a monitoring GaN device, it is difficult to improve the accuracy of compensating for the Idq drift due to differences in characteristics between the RF amplification GaN device and the monitoring GaN device.

Also with the related-art configuration, it is difficult to improve the accuracy of compensating for the Idq drift characteristic due to variation in temperature characteristics of GaN devices.

### SUMMARY

According to an aspect of the embodiments of the invention, there is provided a transmission device including a first amplifier, a second amplifier, and a digital signal processor. The digital signal processor is configured to calculate first distortion compensation coefficients based on a first amplified signal obtained by amplifying an input signal by the first amplifier, set a first distortion compensation coefficient reference range used to perform distortion compensation on the input signal based on power of the input signal and the first distortion compensation coefficients, calculate second distortion compensation coefficients based on a second amplified signal obtained by amplifying the input signal by the second amplifier, set a second distortion compensation coefficient reference range used to perform distortion compensation on the input signal based on the power of the input signal and the second distortion compensation coefficients, and calculate a correction coefficient for correcting the second compensation coefficients based on the first distortion compensation coefficient reference range and the second distortion compensation coefficient reference range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an example of Idq drift;

FIG. 2 is a block diagram illustrating an exemplary configuration of a base station;

FIG. 3 is drawing illustrating an exemplary configuration of a transmission device;

FIG. 4 is a drawing illustrating an exemplary configuration of a computation unit;

FIG. 5 is drawing used to describe an exemplary process of correcting a distortion compensation characteristic;

FIG. 6 is drawing illustrating an example of a first correction coefficient;

FIG. 7 is a drawing illustrating exemplary information stored in a memory;

FIG. 8 is drawing used to describe an exemplary process of correcting a distortion compensation characteristic;

FIG. 9 is drawing illustrating exemplary second correction coefficients;

FIG. 10 is a flowchart illustrating an exemplary process performed by a base station;

FIG. 11 is a flowchart illustrating another exemplary process performed by a base station; and

FIG. 12 is a flowchart illustrating another exemplary process performed by a base station.

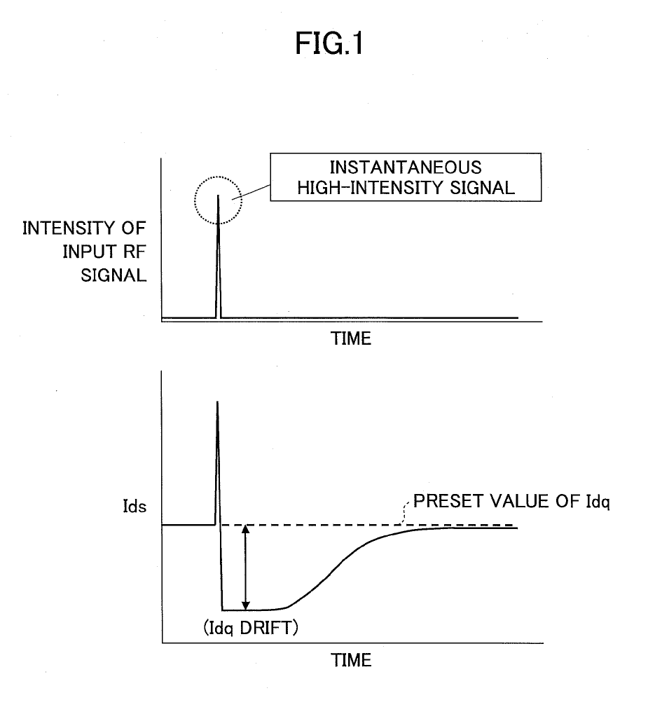

### DESCRIPTION OF EMBODIMENTS

Preferred embodiments of the present invention are described below with reference to the accompanying drawings.

Throughout the accompanying drawings, the same reference numbers are used for components having the same functions, and overlapping descriptions of those components are omitted.

### <Base Station>

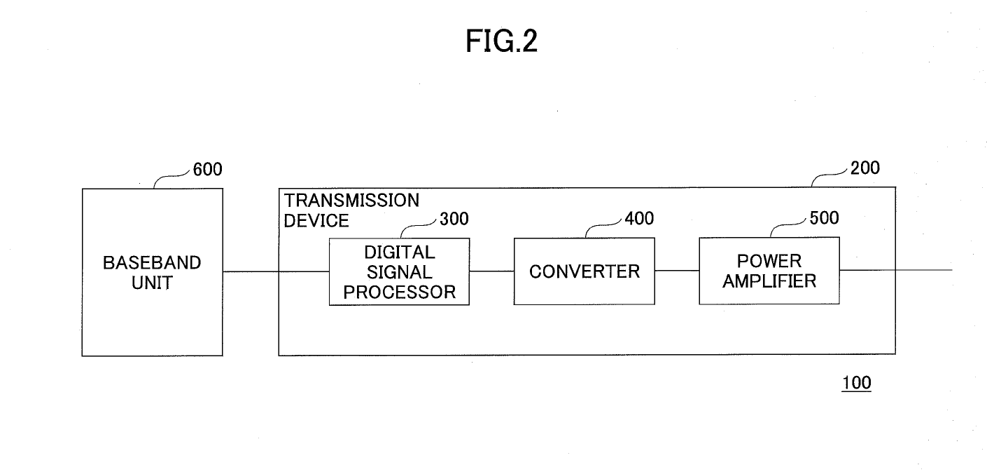

FIG. 2 is a drawing illustrating a base station 100. FIG. 2 mainly illustrates a hardware configuration of the base station 100.

The base station 100 may include a baseband unit (BBU) 600 (or baseband processor 600) and a transmission device (transmitter) 200. The transmission device 200 may be referred to as a remote radio head (RRH). The baseband unit 600 performs baseband signal processing. More specifically, the baseband unit 600 processes data transmitted and received to and from a network. The baseband unit 600 may include, for example, a digital signal processor (DSP). Also, the baseband unit 600 may include a field programmable gate array (FPGA). Further, the baseband unit 600 may include a dedicated large-scale integrated (LSI) circuit.

The baseband unit 600 sends data to the transmission device 200. For example, the baseband unit 600 may be configured to convert an electric signal into an optical signal and send the optical signal via an optical fiber to the transmission device 200. Alternatively, the baseband unit 600 may be configured to convert a parallel signal into a serial signal and send the serial signal via a digital signal transmission channel to the transmission device 200.

Also, the baseband unit 600 may be configured to convert an optical signal received from the transmission device 200 into an electric signal and process the electric signal. Alternatively, the baseband unit 600 may be configured to convert a serial signal received from the transmission device 200 into a parallel signal and process the parallel signal.

The transmission device 200 is a radio communication unit of the base station 100. The transmission device 200 may include a digital signal processor 300, a converter 400, and a power amplifier 500.

A data signal from the baseband unit 600 is input to the digital signal processor 300. The digital signal processor 300 may be implemented, for example, by an FPGA or an application specific integrated circuit (ASIC). The baseband unit 600 and the digital signal processor 300 may be connected to each other via a connector such as a Common Public Radio Interface (CPRI). The digital signal processor 300 processes the data signal received from the baseband unit 600. Signal processing performed by the digital signal processor 300 may include a distortion compensation process. The digital signal processor 300 inputs the processed data signal to the converter 400.

The converter 400 is connected to the digital signal processor 300. The converter 400 converts the data signal processed by the digital signal processor 300 into an analog signal. The converter 400 inputs the analog signal to the power amplifier 500.

The power amplifier 500 is connected to the converter 400. The power amplifier 500 amplifies the power of the analog signal received from the converter 400. The power amplifier 500 transmits the amplified signal via an antenna (not shown). The power amplifier 500 also inputs an amplified signal to the converter 400.

The converter 400 down-converts the amplified signal received from the power amplifier 500. The converter 400 also converts the down-converted signal into a digital signal. The converter 400 inputs the digital signal to the digital signal processor 300.

The digital signal processor 300 performs a distortion compensation process based on the digital signal received from the converter 400.

### <Transmission Device>

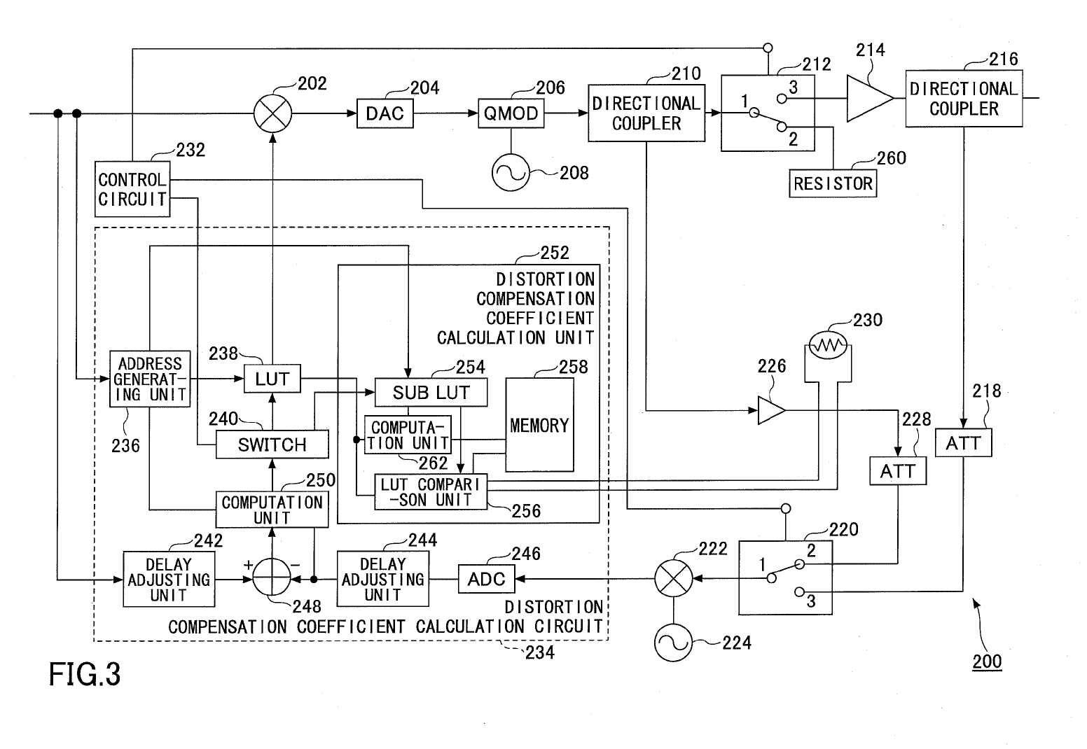

FIG. 3 is a drawing illustrating an exemplary configuration of the transmission device 200. The transmission device 200 performs distortion compensation according to a Digital Predistortion (DPD) method.

The transmission device 200 may include a mixer 202, a D/A converter 204, a quadrature modulator (QMOD) 206, local oscillators 208 and 224, a directional coupler 210, switching units 212 and 220, a first amplifier 214, and a second amplifier 226.

The transmission device 200 may also include a directional coupler 216, attenuators 218 and 228, a temperature monitoring circuit 230, a control circuit 232, a distortion compensation coefficient calculation circuit 234, and a resistor 260.

The distortion compensation coefficient calculation circuit 234 may include an address generating unit 236, a look-up table (LUT) 238, a switch 240, delay adjusting units 242 and 244, an A/D converter 246, a computation unit 250, and a distortion compensation coefficient calculation unit 252. The distortion compensation coefficient calculation unit 252 may include a sub LUT 254, an LUT comparison unit 256, a computation unit 262, and a memory 258. The distortion compensation coefficient calculation circuit 234 may be implemented by an FPGA.

According to an embodiment, the distortion compensation coefficient calculation circuit 234 generates an LUT for the second amplifier 226 and an LUT for the first amplifier 214 based on a training signal. The training signal may be input from the baseband unit 600 or may be input from another source. The distortion compensation coefficient calculation circuit 234 compares the LUT for the second amplifier 226 with the LUT for the first amplifier 214 and obtains a first correction coefficient α for correcting a difference between the LUTs. The distortion compensation coefficient calculation circuit 234 stores the first correction coefficient α in an internal memory. With the stored first correction coefficient α, it is possible to correct the difference between the LUT for the second amplifier 226 and the LUT for the first amplifier 214 at the ambient (or normal) temperature. The first correction coefficient α may be obtained during a factory test on the transmission device 200.

When a temperature changes, the degree of the Idq drift changes and the change in the degree of the Idq drift causes an output power and characteristics of the LUTs to change. Here, the amounts of change of the LUTs for the second amplifier 226 and the first amplifier 214 due to a temperature change differ from each other. For this reason, the transmission device 200 of the present embodiment obtains temperature information and calculates a second correction coefficient β for correcting a difference between the LUT for the second amplifier 226 and the LUT for the first amplifier 214. The distortion compensation coefficient calculation circuit 234 stores the second correction coefficient β in an internal memory. With the stored second correction coefficient β, it is possible to correct the difference between the LUT for the second amplifier 226 and the LUT for the first amplifier 214 when the temperature changes. The second correction coefficient β may be obtained when manufacturing samples of the transmission device 200. For example, the second correction coefficient β may be obtained for some of the samples of the transmission device 200 that are selected in advance because it is time-consuming to obtain the second correction coefficient β for all samples of the transmission device 200. The obtained second correction coefficient β is set as an initial value.

When the transmission device 200 is in operation, the distortion compensation coefficient calculation circuit 234 obtains temperature information and calculates an additional second correction coefficient β for correcting a difference between the LUT for the second amplifier 226 and the LUT for the first amplifier 214. With the additional second correction coefficient β, it is possible to further reduce the difference between the LUT for the second amplifier 226 and the LUT for the first amplifier 214. Reducing the difference between the LUT for the second amplifier 226 and the LUT for the first amplifier 214 makes it possible to improve the accuracy of compensating for the Idq drift characteristic. Improving the accuracy of compensating for the Idq drift characteristic makes it possible to reduce the difference between distortion compensation coefficients before and after the transmission device 200, which has been activated, starts a transmission process. Also, reducing a difference between distortion compensation coefficients obtained before and after the start of the transmission process makes it possible to reduce time necessary to complete calculations of the distortion compensation coefficients and thereby makes it possible to reduce the power leakage to an adjacent channel even in a device such as a GaN device where the gain change increases due to the Idq drift.

### <Process for Obtaining First Correction Coefficient α>

In an exemplary process for obtaining the first correction coefficient α, a test signal for training (which is hereafter simply referred to as a “test signal”) is input to the transmission device 200.

For example, the test signal is input to the transmission device 200 when the transmission device 200 is manufactured. The test signal may be input to the transmission device 200 at an ambient (normal) temperature.

The control circuit 232 controls the switching unit 212 so that an output signal from the directional coupler 210 is input to the resistor 260. That is, the control circuit 232 controls the switching unit 212 to connect a terminal 1 and a terminal 2. In other words, the control circuit 232 controls the switching unit 212 such that the output signal from the directional coupler 210 is terminated.

The control circuit 232 also controls the switching unit 220 so that an output signal from the attenuator 228 is input to the mixer 222. That is, the control circuit 232 controls the switching unit 220 to connect a terminal 1 and a terminal 2.

Further, the control circuit 232 controls the switch 240 so that an output signal from the computation unit 250 is input to the distortion compensation coefficient calculation unit 252.

The test signal input to the transmission device 200 is input to the D/A converter 204, the address generating unit 236, and the delay adjusting unit 242.

The D/A converter 204 converts the test signal into an analog signal and inputs the analog signal to the quadrature modulator (QMOD) 206.

The quadrature modulator 206 is connected to the D/A converter 204. The quadrature modulator 206 performs quadrature modulation on a carrier signal from the local oscillator 208 according to the analog signal input from the D/A converter 204. The quadrature modulator 206 inputs the quadrature-modulated analog signal to the directional coupler 210.

The directional coupler 210 is connected to the quadrature modulator 206. The directional coupler 210 inputs the quadrature-modulated signal received from the quadrature modulator 206 to the switching unit 212 and also inputs a part of the quadrature-modulated signal to the second amplifier 226.

The switching unit 212 is connected to the directional coupler 210. The switching unit 212 terminates the quadrature-modulated signal received from the directional coupler 210 with the resistor 260.

The second amplifier 226 is connected to the directional coupler 210. The second amplifier 226 amplifies the quadrature-modulated signal received from the directional coupler 210. The second amplifier 226 is a device for monitoring. The second amplifier 226 may include GaN or GaAs as a material. Also, the second amplifier 226 may be implemented by a laterally-diffused metal oxide semiconductor (LDMOS). The second amplifier 226 inputs the amplified signal to the attenuator 228.

The attenuator 228 is connected to the second amplifier 226. The attenuator 228 attenuates the amplified signal from the second amplifier 226 to an appropriate signal level. The attenuator 228 inputs the attenuated signal to the switching unit 220.

The switching unit 220 is connected to the attenuator 228. The switching unit 220 inputs the attenuated signal from the attenuator 220 to the mixer 222.

The mixer 222 is connected to the switching unit 220. The mixer 222 down-converts the signal from the switching unit 220 based on a carrier signal from the local oscillator 224. The mixer 222 inputs the down-converted signal to the A/D converter 246.

The A/D converter 246 is connected to the mixer 222. The A/D converter 246 converts the down-converted signal from the mixer 222 into a digital signal. The A/D converter 246 inputs the digital signal to the delay adjusting unit 244.

The delay adjusting unit 244 is connected to the A/D converter 246. The delay adjusting unit 244 inverts the digital signal from the A/D converter 246 and inputs the inverted signal to an adder 248. The delay adjusting unit 244 adjusts the timing to input the inverted digital signal to the adder 248 in accordance with the input timing of the delay adjusting unit 242. For example, the delay adjusting unit 244 adjusts the timing to input the digital signal so that the digital signal is input to the adder 248 at substantially the same timing as the delay adjusting unit 242 inputs a digital signal (the test signal) to the adder 248.

The delay adjusting unit 242 inputs the test signal to the adder 248. The delay adjusting unit 242 adjusts the timing to input the test signal so that the test signal is input to the adder 248 at substantially the same timing as the delay adjusting unit 244 inputs the digital signal to the adder 248.

The adder 248 is connected to the delay adjusting units 242 and 244. The adder 248 obtains a differential signal between the test signal input from the delay adjusting unit 242 and the digital signal input from the delay adjusting unit 244. The adder 248 inputs the differential signal to the computation unit 250.

The computation unit 250 is connected to the adder 248. The computation unit 250 calculates a distortion compensation coefficient h2n(p) for multiplying an input signal based on the differential signal from the adder 248. In “h2n(p)”, “2” indicates that the distortion compensation coefficient is calculated based on a signal amplified by the second amplifier 226, “n” indicates the number of repetitions, and “p” indicates the power (input power) of the input signal and is represented by a formula p=(I²+Q²) (where I indicates the value of an I signal and Q indicates the value of a Q signal). Accordingly, a distortion compensation coefficient h2k(p) (where k is an integer greater than or equal to 1, i.e., h2k(p) indicates any one of calculated distortion compensation coefficients) is calculated repeatedly according to a difference between an input signal and a feedback signal.

Here, may be obtained by a formula “(I²+Q²)(1/2)” instead of (I²+Q²).

The address generating unit 236 obtains a power p based on an input signal on which distortion compensation has not been performed, and generates an address signal based on the power p. The address signal indicates, for example, a 10-bit address value (one of 0 through 1023) that is determined based on the level of the power p. Also, when the distortion compensation coefficient is updated in the LUT 238, the address generating unit 236 outputs the address signal with delay.

### <Computation Unit 250>

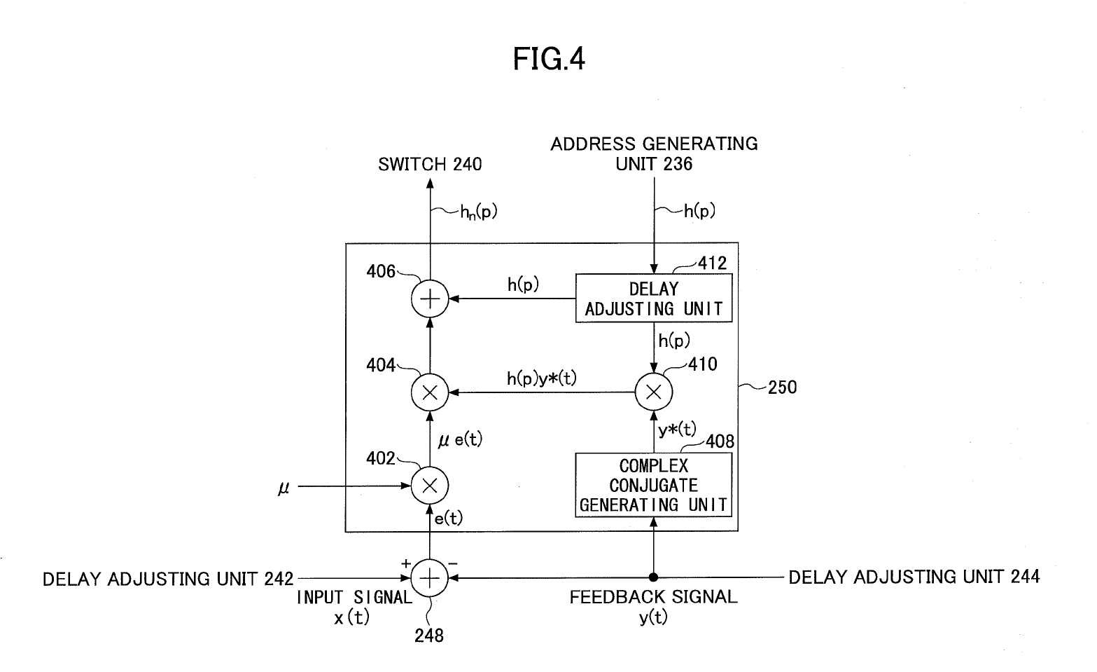

FIG. 4 is a drawing illustrating an exemplary configuration of the computation unit 250.

In the example of FIG. 4, it is assumed that an nth distortion compensation coefficient hn(p) is calculated. Also in FIG. 4, it is assumed that the distortion compensation coefficient hn(p) is calculated by adaptive signal processing using a least mean square (LMS) algorithm. Any other algorithm may also be used to calculate the distortion compensation coefficient.

In the descriptions below, x(t) is a complex representation of an input signal composed of an I signal and a Q signal, y(t) is a complex representation of a feedback signal corresponding to the input signal, and e(t) indicates a differential signal.

The adder 248 inputs the differential signal e(t) to a multiplier 402.

The multiplier 402 is connected to the adder 248.

The multiplier 402 multiplies the differential signal e(t) by μ that represents a step size parameter indicating an update step size. The multiplier 402 inputs the signal μ e(t) obtained by multiplying the differential signal e(t) by μ to a multiplier 404.

The output signal y(t) from the delay adjusting unit 244 is input to a complex conjugate generating unit 408.

The complex conjugate generating unit 408 is connected to the delay adjusting unit 244. The complex conjugate generating unit 408 generates a complex conjugate y*(t) of the output signal y(t). The complex conjugate generating unit 408 inputs the complex conjugate y*(t) to a multiplier 410.

On the other hand, an address signal h(p) is input from the address generating unit 236 to a delay adjusting unit 412.

The delay adjusting unit 412 is connected to the address generating unit 236. The delay adjusting unit 412 inputs the address signal h(p) to an adder 406 and the multiplier 410. The delay adjusting unit 412 adjusts the timing to input the address signal h(p) to the adder 406.

The multiplier 410 is connected to the delay adjusting unit 412 and the complex conjugate generating unit 408. The multiplier 410 multiplies the address signal h(p) from the delay adjusting unit 412 by the complex conjugate y*(t) from the complex conjugate generating unit 408. The multiplier 410 inputs the signal h(p)y*(t) obtained by multiplying the address signal h(p) by the complex conjugate y*(t) to the multiplier 404.

The multiplier 404 is connected to the multipliers 402 and 410. The multiplier 404 multiplies the signal pe(t) from the multiplier 402 by the signal h(p)y*(t) from the multiplier 410. Here, y*(t) is the complex conjugate of y(t). The multiplier 404 inputs the signal h(p)y*(t)pe(t) to the adder 406.

The adder 406 is connected to the multiplier 404 and the delay adjusting unit 412. The adder 406 adds the signal h(p)y*(t)μe(t) output from the multiplier 404 and the signal h(p) output from the delay adjusting unit 412 to obtain an nth distortion compensation coefficient hn(p). The adder 406 inputs the nth distortion compensation coefficient hn(p) to the switch 240.

The switch 240 is connected to the computation unit 250 and the control circuit 232. Based on a control signal from the control circuit 232, the switch 240 switches destinations of the distortion compensation coefficient received from the computation unit 250, between the LUT 238 and the sub LUT 254. Here, the switch 240 selects the sub LUT 254 as the destination of the distortion compensation coefficient from the computation unit 250.

The sub LUT 254 is a table where distortion compensation coefficients output from the computation unit 250 are stored as distortion compensation coefficients h(p) in association with address values determined based on the power p (or power levels) of the input signal. When an address signal is supplied from the address generating unit 236, the sub LUT 254 retrieves a distortion compensation coefficient corresponding to the power p of the input signal based on the address signal, and outputs the retrieved distortion compensation coefficient to the LUT comparison unit 256.

The control circuit 232 controls the switching unit 212 so that an output signal from the directional coupler 210 is input to the first amplifier 214. That is, the control circuit 232 controls the switching unit 212 to connect the terminal 1 and a terminal 3.

The control circuit 232 also controls the switching unit 220 so that an output signal from the attenuator 218 is input to the mixer 222. That is, the control circuit 232 controls the switching unit 220 to connect the terminal 1 and a terminal 3.

The D/A converter 204 converts the test signal into an analog signal and inputs the analog signal to the quadrature modulator (QMOD) 206.

The quadrature modulator 206 performs quadrature modulation on a carrier signal from the local oscillator 208 according to the analog signal input from the D/A converter 204. The quadrature modulator 206 inputs the quadrature-modulated analog signal to the directional coupler 210.

The directional coupler 210 inputs the quadrature-modulated signal received from the quadrature modulator 206 to the switching unit 212 and also inputs a part of the quadrature-modulated signal to the second amplifier 226.

The second amplifier 226 inputs the part of the quadrature-modulated signal to the attenuator 228. The attenuator 228 attenuates the quadrature-modulated signal and inputs the attenuated signal to the terminal 2 of the switching unit 220. In this case, however, because the terminal 1 and the terminal 3 of the switching unit 220 are connected, the signal from the attenuator 228 is not input to the mixer 222.

The switching unit 212 inputs the quadrature-modulated signal received from the directional coupler 210 to the first amplifier 214.

The first amplifier 214 is connected to the switching unit 212. The first amplifier 214 may include a GaN device for RF amplification. The first amplifier 214 amplifies the quadrature-modulated signal received from the directional coupler 210. The first amplifier 214 inputs the amplified quadrature-modulated signal to the directional coupler 216.

The directional coupler 216 outputs the signal received from the first amplifier 214 and also inputs a part of the signal to the attenuator 218.

The attenuator 218 is connected to the directional coupler 216. The attenuator 218 attenuates the amplified signal from the first amplifier 214 to an appropriate signal level. The attenuator 218 inputs the attenuated signal to the switching unit 220.

The switching unit 220 is connected to the attenuator 218. The switching unit 220 inputs the attenuated signal from the attenuator 220 to the mixer 222.

The mixer 222 down-converts the signal from the switching unit 220 based on a carrier signal from the local oscillator 224. The mixer 222 inputs the down-converted signal to the A/D converter 246.

The A/D converter 246 converts the down-converted signal from the mixer 222 into a digital signal. The A/D converter 246 inputs the digital signal to the delay adjusting unit 244.

The delay adjusting unit 244 inverts the digital signal from the A/D converter 246 and inputs the inverted signal to the adder 248. The delay adjusting unit 244 adjusts the timing to input the inverted digital signal to the adder 248 in accordance with the input timing of the delay adjusting unit 242. For example, the delay adjusting unit 244 adjusts the timing to input the digital signal so that the digital signal is input to the adder 248 at substantially the same timing as the delay adjusting unit 242 inputs a digital signal (the test signal) to the adder 248.

The delay adjusting unit 242 inputs the test signal to the adder 248. The delay adjusting unit 242 adjusts the timing to input the test signal so that the test signal is input to the adder 248 at substantially the same timing as the delay adjusting unit 244 inputs the digital signal to the adder 248.

The adder 248 obtains a differential signal between the test signal input from the delay adjusting unit 242 and the digital signal input from the delay adjusting unit 244. The adder 248 inputs the differential signal to the computation unit 250.

The computation unit 250 calculates a distortion compensation coefficient h1n(p) for multiplying an input signal based on the differential signal from the adder 248. In “h1n(p)”, “1” indicates that the distortion compensation coefficient is calculated based on a signal amplified by the first amplifier 226, “n” indicates the number of repetitions, and “p” indicates the power (input power) of the input signal and is represented by a formula p=(I²+Q²) (where I indicates the value of an I signal and Q indicates the value of a Q signal). Accordingly, the distortion compensation coefficient h1k(p) (where k is an integer greater than or equal to 1, i.e., h1k(p) indicates any one of calculated distortion compensation coefficients) is calculated repeatedly according to a difference between an input signal and a feedback signal. Here, “p” may be obtained by a formula “(I²+Q²)(1/2)” instead of (I²+Q²).

The computation unit 250 inputs the distortion compensation coefficient h1n(p) to the switch 240.

Based on a control signal from the control circuit 232, the switch 240 switches the destination of the distortion compensation coefficient received from the computation unit 250 to the LUT 238.

The switch 240 inputs the distortion compensation coefficient h1n(p) received from the computation unit 250 to the LUT 238.

The LUT 238 is a table where distortion compensation coefficients output from the computation unit 250 are stored as distortion compensation coefficients h(p) in association with address values determined based on the power p (or power levels) of the input signal. When an address signal is supplied from the address generating unit 236, the LUT 238 retrieves a distortion compensation coefficient h(p) corresponding to the power p of the input signal based on the address signal, and outputs the retrieved distortion compensation coefficient h(p) to the LUT comparison unit 256.

The LUT comparison unit 256 calculates a correction coefficient (which is hereafter referred to as a “first correction coefficient α”) based on the distortion compensation coefficient received from the sub LUT 254 and the distortion compensation coefficient received from the LUT 238. The LUT comparison unit 256 calculates a correction coefficient (which is hereafter referred to as a “first correction coefficient α”) based on the distortion compensation coefficient received from the sub LUT 254 and the distortion compensation coefficient received from the LUT 238. For example, the LUT comparison unit 256 calculates the first correction coefficient α based on a difference between the distortion correction coefficient of the first amplifier 214 and the distortion correction coefficient of the second amplifier 226. Here, calculating the first correction coefficient α based on the difference between distortion correction coefficients is just an example, and the first correction coefficient α may be obtained by any other method.

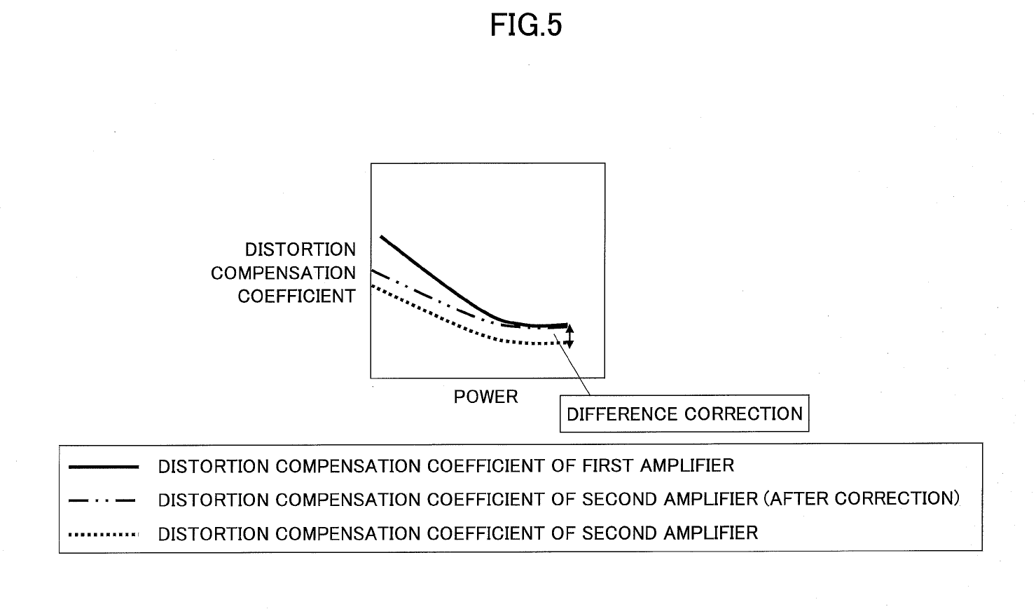

FIG. 5 is drawing used to describe an exemplary process performed by the LUT comparison unit 256.

In FIG. 5, the horizontal axis indicates power and the vertical axis indicates the distortion compensation coefficient.

FIG. 5 illustrates a distortion compensation coefficient of the first amplifier 214, a distortion compensation coefficient of the second amplifier 226, and a corrected distortion compensation coefficient of the second amplifier 226 in association with the power of an input signal.

As illustrated in FIG. 5, there is a difference between the distortion compensation coefficient of the first amplifier 214 and the distortion compensation coefficient of the second amplifier 226 throughout the power range (i.e., both in the low power range and the high power range). The different is greater in the low power range than in the high power range.

The distortion compensation coefficient of the second amplifier 226 is corrected by the first correction coefficient α to make the distortion compensation coefficient of the second amplifier 226 close to the distortion compensation coefficient of the first amplifier 214. In this example, the distortion compensation coefficient of the second amplifier 226 becomes closest to the distortion compensation coefficient of the first amplifier 214 near the operating power level.

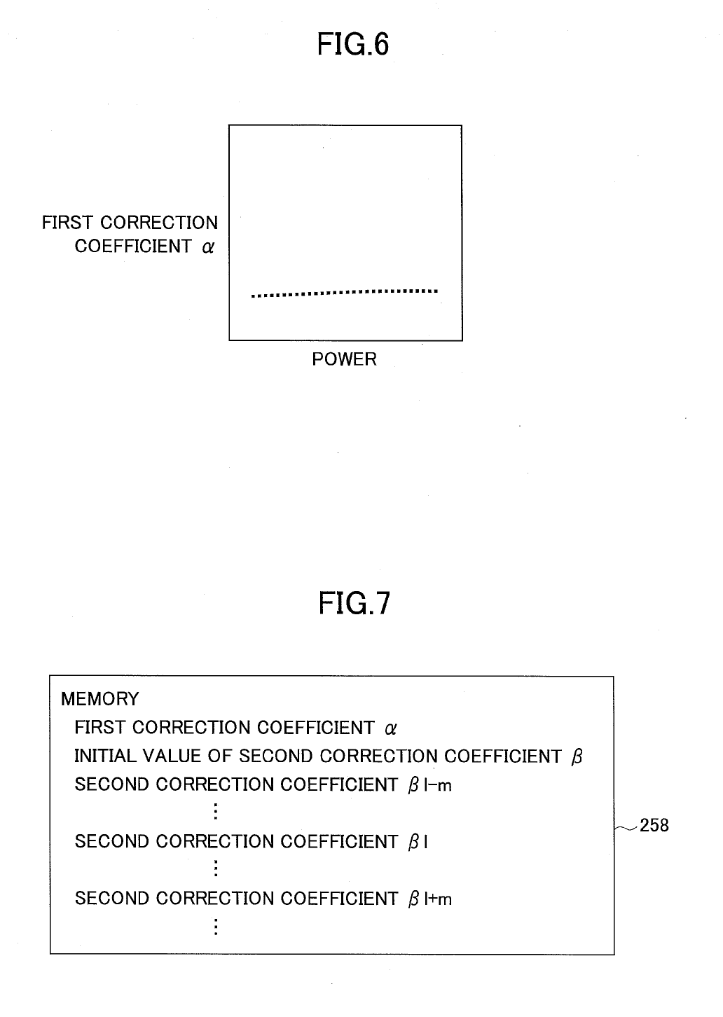

FIG. 6 is drawing illustrating an example of the first correction coefficient α.

The first correction coefficient α is set at substantially the same value regardless of the power level. The first correction coefficient α mainly corrects the distortion compensation coefficient in the high power range.

The LUT comparison unit 256 stores the first correction coefficient α in the memory 258.

### <Process for Obtaining Second Correction Coefficient β>

The Idq drift characteristic changes depending on the temperature. Also, the temperature characteristic of the Idq drift varies depending on amplifiers. Accordingly, the accuracy of correcting the distortion compensation coefficient is affected by the change in the Idq drift characteristic caused by a temperature change.

The second correction coefficient β is used to compensate for the change in the Idq drift characteristic caused by a temperature change. The initial value of the second correction coefficient β is stored in the memory 258. The initial value of the second correction coefficient β may be set based on the results of tests performed using pre-selected sample products.

A plurality of second correction coefficients β may be set for different temperatures. For example, second correction coefficients β1−m, β1, and α1+m may be set for different temperatures.

FIG. 7 is a drawing illustrating exemplary correction coefficients stored in the memory 258.

In this example, the memory 258 stores the first correction coefficient α, the initial value of the second correction coefficient β, the second correction coefficient β1−m, . . . , the second correction coefficient β1, . . . , the second correction coefficient β1+m, . . . .

When obtaining the second correction coefficients β, β1−m, . . . , β1, . . . , β1+m, . . . , a test signal is input to the transmission device 200.

The control circuit 232 controls the switching unit 212 so that an output signal from the directional coupler 210 is input to the resistor 260.

The control circuit 232 also controls the switching unit 220 so that an output signal from the attenuator 228 is input to the mixer 222.

Further, the control circuit 232 controls the switch 240 so that an output signal from the computation unit 250 is input to the distortion compensation coefficient calculation unit 252.

The test signal input to the transmission device 200 is input to the D/A converter 204, the address generating unit 236, and the delay adjusting unit 242.

The D/A converter 204 converts the test signal into an analog signal and inputs the analog signal to the quadrature modulator 206.

The quadrature modulator 206 performs quadrature modulation on a carrier signal from the local oscillator 208 according to the analog signal input from the D/A converter 204. The quadrature modulator 206 inputs the quadrature-modulated analog signal to the directional coupler 210.

The directional coupler 210 inputs the quadrature-modulated signal received from the quadrature modulator 206 to the switching unit 212 and also inputs a part of the quadrature-modulated signal to the second amplifier 226.

The switching unit 212 terminates the quadrature-modulated signal received from the directional coupler 210 with the resistor 260.

The second amplifier 226 amplifies the quadrature-modulated signal received from the directional coupler 210. The second amplifier 226 inputs the amplified signal to the attenuator 228.

The attenuator 228 attenuates the amplified signal from the second amplifier 226 to an appropriate signal level. The attenuator 228 inputs the attenuated signal to the switching unit 220.

The switching unit 220 inputs the attenuated signal from the attenuator 220 to the mixer 222.

The mixer 222 down-converts the signal from the switching unit 220 based on a carrier signal from the local oscillator 224. The mixer 222 inputs the down-converted signal to the A/D converter 246.

The A/D converter 246 converts the down-converted signal from the mixer 222 into a digital signal. The A/D converter 246 inputs the digital signal to the delay adjusting unit 244.

The delay adjusting unit 244 inverts the digital signal from the A/D converter 246 and inputs the inverted signal to the adder 248. The delay adjusting unit 244 adjusts the timing to input the inverted digital signal to the adder 248 in accordance with the input timing of the delay adjusting unit 242. For example, the delay adjusting unit 244 adjusts the timing to input the digital signal so that the digital signal is input to the adder 248 at substantially the same timing as the delay adjusting unit 242 inputs a digital signal (the test signal) to the adder 248.

The delay adjusting unit 242 inputs the test signal to the adder 248. The delay adjusting unit 242 adjusts the timing to input the test signal so that the test signal is input to the adder 248 at substantially the same timing as the delay adjusting unit 244 inputs the digital signal to the adder 248.

The adder 248 obtains a differential signal between the test signal input from the delay adjusting unit 242 and the digital signal input from the delay adjusting unit 244. The adder 248 inputs the differential signal to the computation unit 250.

The computation unit 250 is connected to the adder 248. The computation unit 250 calculates a distortion compensation coefficient h2n(p) for multiplying an input signal based on the differential signal from the adder 248. The computation unit 250 inputs the distortion compensation coefficient h2n(p) to the switch 240.

Based on a control signal from the control circuit 232, the switch 240 switches the destination of the distortion compensation coefficient received from the computation unit 250 to the sub LUT 254.

The sub LUT 254 retrieves a distortion compensation coefficient corresponding to the power p of the input signal based on an address signal supplied from the address generating unit 236, and outputs the retrieved distortion compensation coefficient to the LUT comparison unit 256.

The LUT comparison unit 256 obtains temperature information from the temperature monitoring circuit 230. The LUT comparison unit 256 selects a second correction coefficient β corresponding to the temperature information from the memory 258. For example, the LUT comparison unit 256 may be configured to select a second correction coefficient β associated with a temperature that is close to the temperature information. The LUT comparison unit 256 corrects the distortion compensation coefficient h2n(p) received from the sub LUT 254 based on the first correction coefficient α and the selected second correction coefficient β. For example, the LUT comparison unit 256 may be configured to add the first correction coefficient α and the selected second correction coefficient β to the distortion compensation coefficient h2n(p). This is just an example, and the LUT comparison unit 256 may be configured to correct the distortion compensation coefficient h2n(p) by any other method. The LUT comparison unit 256 retains the corrected distortion compensation coefficient h2n(p).

The control circuit 232 controls the switching unit 212 so that an output signal from the directional coupler 210 is input to the first amplifier 214.

Also, the control circuit 232 controls the switching unit 220 so that an output signal from the attenuator 218 is input to the mixer 222.

The D/A converter 204 converts the test signal into an analog signal and inputs the analog signal to the quadrature modulator 206.

The quadrature modulator 206 performs quadrature modulation on a carrier signal from the local oscillator 208 according to the analog signal input from the D/A converter 204. The quadrature modulator 206 inputs the quadrature-modulated analog signal to the directional coupler 210.

The directional coupler 210 inputs the quadrature-modulated signal received from the quadrature modulator 206 to the switching unit 212 and also inputs a part of the quadrature-modulated signal to the second amplifier 226.

The switching unit 212 inputs the quadrature-modulated signal received from the directional coupler 210 to the first amplifier 214.

The first amplifier 214 amplifies the quadrature-modulated signal received from the directional coupler 210. The first amplifier 214 inputs the amplified quadrature-modulated signal to the directional coupler 216.

The directional coupler 216 outputs the signal received from the first amplifier 214 and also inputs a part of the signal to the attenuator 218.

The attenuator 218 is connected to the directional coupler 216. The attenuator 218 attenuates the amplified signal from the first amplifier 214 to an appropriate signal level. The attenuator 218 inputs the attenuated signal to the switching unit 220.

The switching unit 220 is connected to the attenuator 218. The switching unit 220 inputs the attenuated signal from the attenuator 220 to the mixer 222.

The mixer 222 down-converts the signal from the switching unit 220 based on a carrier signal from the local oscillator 224. The mixer 222 inputs the down-converted signal to the A/D converter 246.

The A/D converter 246 converts the down-converted signal from the mixer 222 into a digital signal. The A/D converter 246 inputs the digital signal to the delay adjusting unit 244.

The delay adjusting unit 244 inverts the digital signal from the A/D converter 246 and inputs the inverted signal to the adder 248. The delay adjusting unit 244 adjusts the timing to input the inverted digital signal to the adder 248 in accordance with the input timing of the delay adjusting unit 242. For example, the delay adjusting unit 244 adjusts the timing to input the digital signal so that the digital signal is input to the adder 248 at substantially the same timing as the delay adjusting unit 242 inputs a digital signal (the test signal) to the adder 248.

The delay adjusting unit 242 inputs the test signal to the adder 248. The delay adjusting unit 242 adjusts the timing to input the test signal so that the test signal is input to the adder 248 at substantially the same timing as the delay adjusting unit 244 inputs the digital signal to the adder 248.

The adder 248 is connected to the delay adjusting units 242 and 244. The adder 248 obtains a differential signal between the test signal input from the delay adjusting unit 242 and the digital signal input from the delay adjusting unit 244. The adder 248 inputs the differential signal to the computation unit 250.

The computation unit 250 calculates a distortion compensation coefficient h1n(p) for multiplying an input signal based on the differential signal from the adder 248. The computation unit 250 inputs the distortion compensation coefficient h1n(p) to the switch 240.

Based on a control signal from the control circuit 232, the switch 240 switches the destination of the distortion compensation coefficient received from the computation unit 250 to the LUT 238.

The switch 240 inputs the distortion compensation coefficient h1n(p) received from the computation unit 250 to the LUT 238.

The LUT 238 retrieves a distortion compensation coefficient corresponding to the power p of the input signal based on an address signal supplied from the address generating unit 236, and outputs the retrieved distortion compensation coefficient to the LUT comparison unit 256.

The LUT comparison unit 256 calculates a second correction coefficient β based on the retained distortion compensation coefficient from the sub LUT 254 and the distortion compensation coefficient received from the LUT 238. More specifically, the LUT comparison unit 256 calculates the second correction coefficient β that is used to make the distortion compensation coefficient from the sub LUT 254 match the distortion compensation coefficient received from the LUT 238. For example, the LUT comparison unit 256 calculates the second correction coefficient β based on a difference between the distortion compensation coefficient from the LUT 238 and the distortion compensation coefficient from the sub LUT 254. Here, calculating the second correction coefficient based on the difference between distortion correction coefficients is just an example, and the second correction coefficient β may be obtained by any other method.

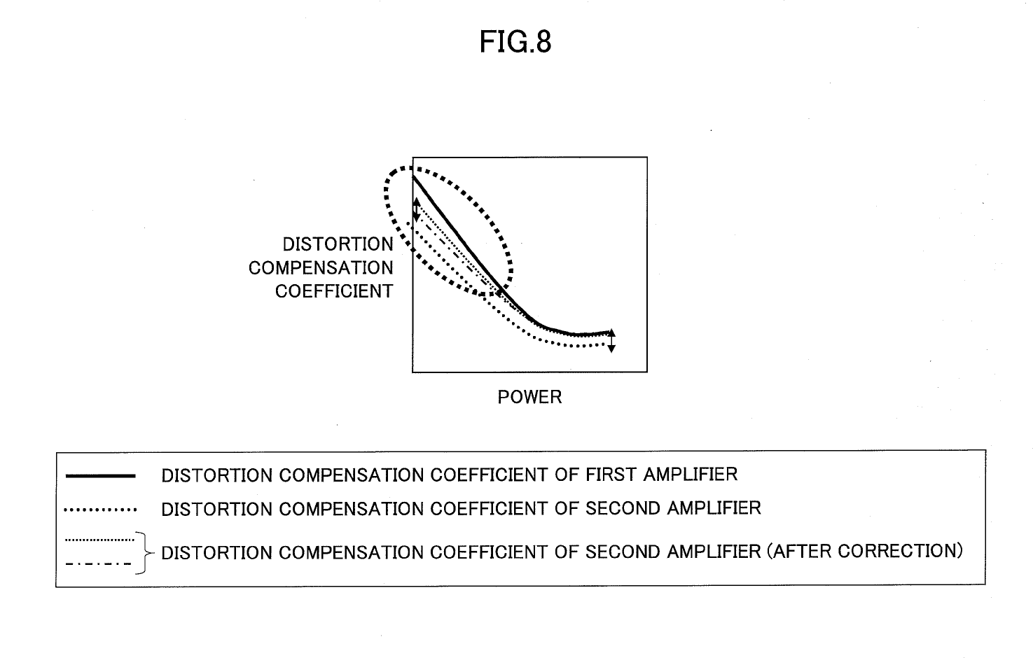

FIG. 8 is a drawing used to describe an exemplary process performed by the LUT comparison unit 256.

In FIG. 8, the horizontal axis indicates power and the vertical axis indicates the distortion compensation coefficient.

FIG. 8 illustrates a distortion compensation coefficient of the first amplifier 214, a distortion compensation coefficient of the second amplifier 226, and corrected distortion compensation coefficients for the second amplifier 226.

As illustrated in FIG. 8, there is a difference between the distortion compensation coefficient of the first amplifier 214 and the distortion compensation coefficient of the second amplifier 226 throughout the power range (i.e., in both the low power range and the high power range). The difference is greater in the low power range than in the high power range.

The distortion compensation coefficient of the second amplifier 226 is corrected by the second correction coefficient β to make the distortion compensation coefficient of the second amplifier 226 be close to the distortion compensation coefficient of the first amplifier 214.

The second correction coefficient β may be calculated when no second correction coefficient β corresponding to the temperature detected by the temperature monitoring circuit 230 is stored in the memory 258. The second correction coefficients β may be associated with temperature ranges.

Below are descriptions of a case where a second correction coefficient β corresponding to the temperature detected by the temperature monitoring circuit 230 is stored in the memory 258. The computation unit 250 calculates a distortion compensation coefficient h1n(p) for multiplying an input signal based on the differential signal from the adder 248. The computation unit 250 inputs the distortion compensation coefficient h1n(p) to the switch 240.

Based on a control signal from the control circuit 232, the switch 240 switches the destination of the distortion compensation coefficient received from the computation unit 250 to the sub LUT 254.

The switch 240 inputs the distortion compensation coefficient h1n(p) received from the computation unit 250 to the sub LUT 254.

The sub LUT 254 retrieves a distortion compensation coefficient corresponding to the power p of the input signal based on an address signal supplied from the address generating unit 236, and outputs the retrieved distortion compensation coefficient to the computation unit 262.

The computation unit 262 obtains a second correction coefficient β corresponding to the temperature detected by the temperature monitoring circuit 230 from the memory 258, and corrects the distortion compensation coefficient received from the sub LUT 254 based on the obtained second correction coefficient β. The computation unit 262 outputs the corrected distortion compensation coefficient to the LUT 238, i.e., updates the LUT 238.

The LUT 238 performs a process based on the distortion compensation coefficient received from the computation unit 262. For example, the LUT 238 inputs the distortion compensation coefficient received from the computation unit 262 to the mixer 202 to perform a distortion compensation process.

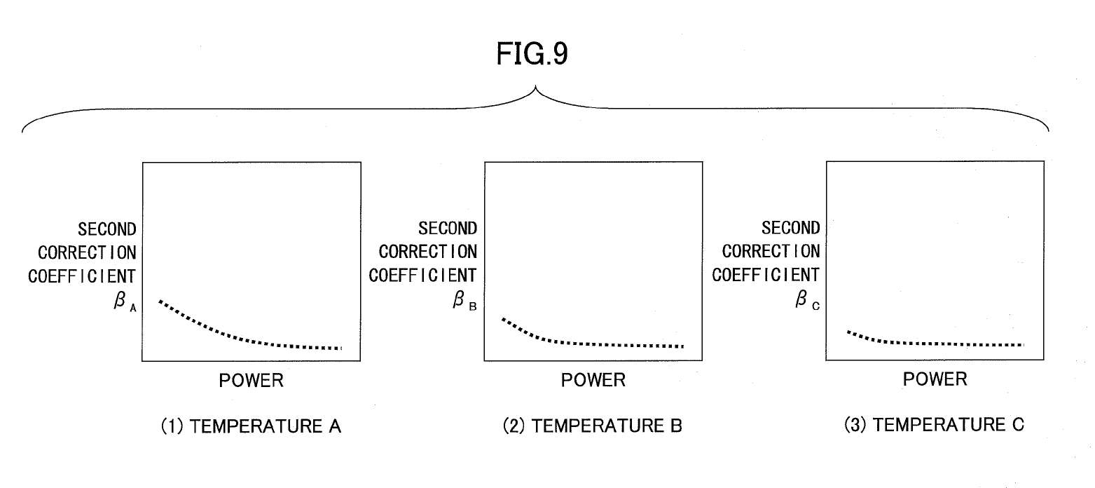

FIG. 9 is drawing illustrating exemplary second correction coefficients β.

The second correction coefficient β is set such that its value is higher in the low power range than in the high power range. In other words, the second correction coefficient β is set such that its value is lower in the high power range than in the low power range. A plurality of second correction coefficients β may be set for different temperatures.

The LUT comparison unit 256 stores the second correction coefficients β in the memory 258.

### <Processes Performed by Base Station>

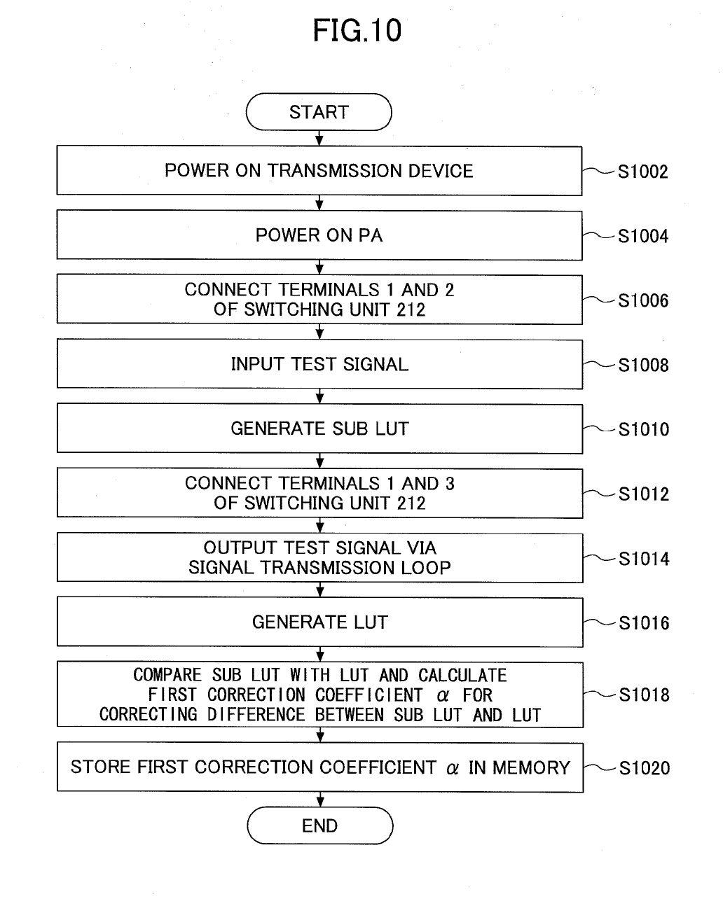

FIGS. 10 through 12 illustrate exemplary processes performed by the base station 100.

FIG. 10 is a flowchart illustrating an exemplary process for setting the first correction coefficient α. This process may be executed when the base station 100 is tested, for example, at the factory.

At step S1002, the transmission device 200 is powered on.

At step S1004, a power amplifier (PA), i.e., the power amplifier 500 of the transmission device 200, is powered on.

At step S1006, the control unit 232 controls the switching unit 212 to connect the terminal 1 and the terminal 2.

At step S1008, a test signal for training is input to the transmission device 200.

At step S1010, the distortion compensation coefficient calculation circuit 234 generates the sub LUT 254.

At step S1012, the control unit 232 controls the switching unit 212 to connect the terminal 1 and the terminal 3.

At step S1014, the test signal is output via a signal transmission loop.

At step S1016, the distortion compensation coefficient calculation circuit 234 generates the LUT 238.

At step S1018, the distortion compensation coefficient calculation circuit 234 compares the sub LUT 254 with the LUT 238, and calculates the first correction coefficient α for correcting a difference between the sub LUT 254 and the LUT 238.

At step S1020, the distortion compensation coefficient calculation circuit 234 stores the first correction coefficient α in the memory 258.

The first correction coefficient α is used to correct the distortion compensation coefficient and thereby compensate for the variation in characteristics of amplifiers. Characteristics of devices such as field-effect transistors (FET) vary from one device to another. Accordingly, there may be variation in characteristics between the first amplifier 214 and the second amplifier 226. Such variation can be corrected through a one-hundred percent test performed at the ambient temperature at the factory.

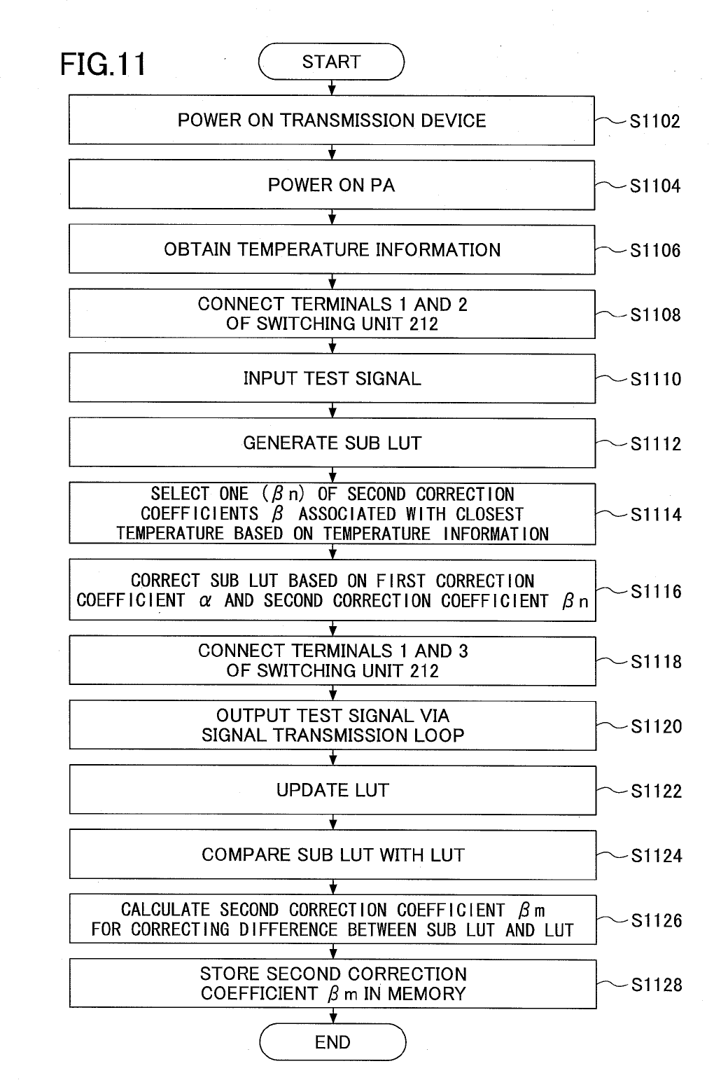

FIG. 11 is a flowchart illustrating an exemplary process for setting the second correction coefficient β

This process may be executed, for example, when the operation of the base station 100 is started.

At step S1102, the transmission device 200 is powered on.

At step S1104, a power amplifier (PA), i.e., the power amplifier 500 of the transmission device 200, is powered on.

At step S1106, the distortion compensation coefficient calculation circuit 234 obtains temperature information from the temperature monitoring circuit 230.

At step S1108, the control unit 232 controls the switching unit 212 to connect the terminal 1 and the terminal 2.

At step S1110, a test signal for training is input to the transmission device 200.

At step S1112, the distortion compensation coefficient calculation circuit 234 generates the sub LUT 254.

At step S1114, the distortion compensation coefficient calculation circuit 234 selects one of the second correction coefficients β stored in the memory 258 that is associated with a temperature closest to the temperature indicated by the temperature information.

At step S1116, the distortion compensation coefficient calculation circuit 234 corrects the sub LUT 254 based on the first correction coefficient α and the selected second correction coefficient β.

At step S1118, the control unit 232 controls the switching unit 212 to connect the terminal 1 and the terminal 3.

At step S1120, the test signal is output via a signal transmission loop.

At step S1122, the distortion compensation coefficient calculation circuit 234 updates the LUT 238.

At step S1124, the distortion compensation coefficient calculation circuit 234 compares the sub LUT 254 with the LUT 238.

At step S1126, the distortion compensation coefficient calculation circuit 234 calculates a second correction coefficient β for correcting a difference between the sub LUT 254 and the LUT 238.

At step S1128, the distortion compensation coefficient calculation circuit 234 stores the calculated second correction coefficient β in the memory 258 in association with the temperature.

The Idq drift characteristic changes due to a temperature change and the temperature characteristic of the Idq drift also varies from one device to another. That is, multiple devices may have different temperature characteristics.

For the above reasons, correcting the sub LUT 254 for the second amplifier 226 and the LUT 238 for the first amplifier 214 solely with the first correction coefficient α may not be sufficient.

According to the present embodiment, the second correction coefficient β is used to compensate for characteristic variation caused by a temperature change. For example, the initial value of the second correction coefficient β may be set based on the results of tests performed using pre-selected sample products, and stored in a memory. A plurality of second correction coefficients β may be set for different temperatures.

Also according to the present embodiment, the first correction coefficient α is used to compensate for the variation in characteristics of transmission devices. The above configuration makes it possible to reduce the number of devices on which temperature tests are performed at the factory.

When the operation of a transmission device is started, another second correction factor β is calculated based on the initial value of the second correction coefficient β stored in the memory to correct a difference between the LUT 238 for the first amplifier 214 and the sub LUT 254 for the second amplifier 226.

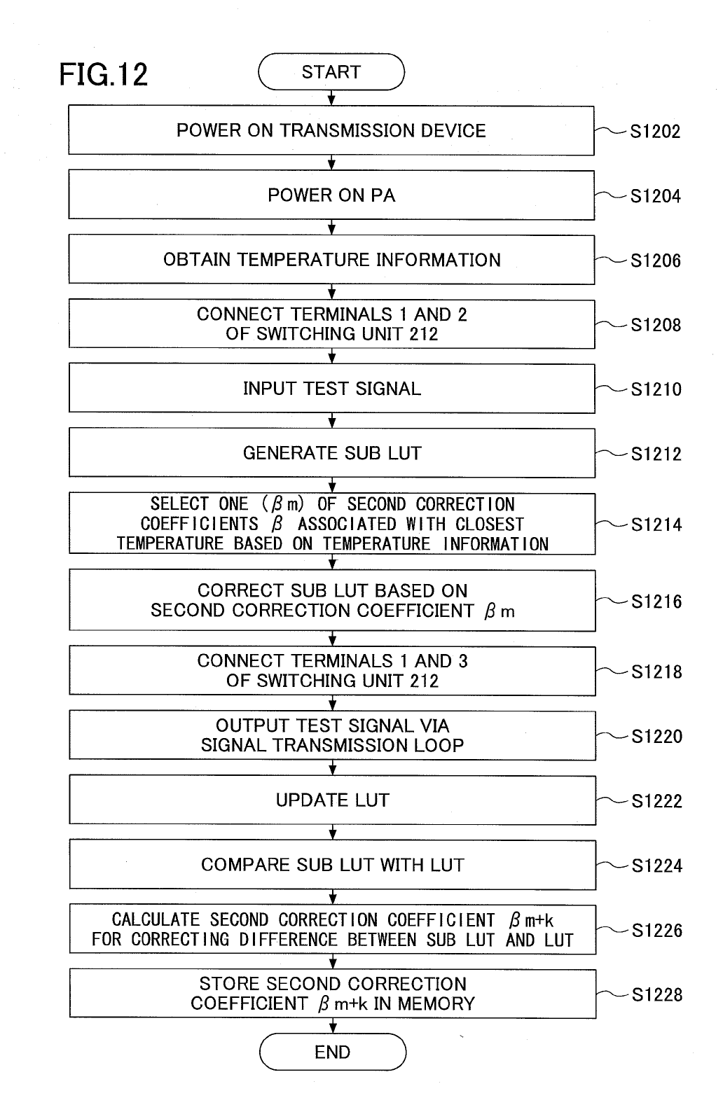

FIG. 12 is a flowchart illustrating an exemplary process for setting the second correction coefficient β

This process may be executed, for example, while the base station 100 is in operation. Also, this process may be executed when the operation of the base station 100 is temporarily stopped and the base station 100 is restarted.

At step S1202, the transmission device 200 is powered on.

At step S1204, a power amplifier (PA), i.e., the power amplifier 500 of the transmission device 200, is powered on.

At step S1206, the distortion compensation coefficient calculation circuit 234 obtains temperature information from the temperature monitoring circuit 230.

At step S1208, the control unit 232 controls the switching unit 212 to connect the terminal 1 and the terminal 2.

At step S1210, a test signal for training is input to the transmission device 200.

At step S1212, the distortion compensation coefficient calculation circuit 234 generates the sub LUT 254.

At step S1214, the distortion compensation coefficient calculation circuit 234 selects one of the second correction coefficients β stored in advance in the memory 258 that is associated with a temperature closest to the temperature indicated by the temperature information.

At step S1216, the distortion compensation coefficient calculation circuit 234 corrects the sub LUT 254 based on the selected second correction coefficient β.

At step S1218, the control unit 232 controls the switching unit 212 to connect the terminal 1 and the terminal 3.

At step S1220, the test signal is output via a signal transmission loop.

At step S1222, the distortion compensation coefficient calculation circuit 234 updates the LUT 238.

At step S1224, the distortion compensation coefficient calculation circuit 234 compares the sub LUT 254 with the LUT 238.

At step S1226, the distortion compensation coefficient calculation circuit 234 calculates a second correction coefficient β for correcting a difference between the sub LUT 254 and the LUT 238.

At step S1228, the distortion compensation coefficient calculation circuit 234 stores the calculated second correction coefficient β in the memory 258 in association with the temperature.

When the transmission device 200 is in operation, the distortion compensation coefficient calculation circuit 234 obtains temperature information and calculates an additional second correction coefficient β for correcting a difference between the LUT 238 for the first amplifier 214 and the sub LUT 254 for the second amplifier 226, and stores the calculated second correction coefficient β in the memory in association with the temperature information.

With the additional second correction coefficient β it is possible to further reduce the difference between the sub LUT 254 for the second amplifier 226 and the LUT 238 for the first amplifier 214. Reducing the difference between the sub LUT 254 for the second amplifier 226 and the LUT 238 for the first amplifier 214 makes it possible to improve the accuracy of compensating for the Idq drift characteristic.

Improving the accuracy of compensating for the Idq drift characteristic makes it possible to reduce the difference between distortion compensation coefficients obtained before and after the transmission unit 200 starts a transmission process. Also, reducing the difference between distortion compensation coefficients obtained before and after the start of the transmission process makes it possible to reduce time necessary to complete calculations of the distortion compensation coefficients and thereby makes it possible to reduce the power leakage to an adjacent channel even in a device such as a GaN device where the gain change increases due to the Idq drift.

The above process may be repeated while the transmission device 200 is in operation to add second correction coefficients β and thereby improve the accuracy of compensating for the influence of the Idq drift. This in turn makes it possible to reduce the time necessary for distortion compensation and thereby makes it possible to reduce the power leakage to an adjacent channel even in a device such as a GaN device where the gain change increases due to the Idq drift.

Thus, an aspect of this disclosure provides a transmission device and a transmission method that can compensate for the Idq drift with reduced time and improved accuracy.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission device, comprising:
a first amplifier;
a second amplifier; and
a digital signal processor configured to
calculate first distortion compensation coefficients based on a first amplified signal obtained by amplifying an input signal by the first amplifier,
set a first distortion compensation coefficient reference range used to perform distortion compensation on the input signal based on power of the input signal and the first distortion compensation coefficients,
calculate second distortion compensation coefficients based on a second amplified signal obtained by amplifying the input signal by the second amplifier,
set a second distortion compensation coefficient reference range used to perform distortion compensation on the input signal based on the power of the input signal and the second distortion compensation coefficients, and
calculate a correction coefficient for correcting the second compensation coefficients based on the first distortion compensation coefficient reference range and the second distortion compensation coefficient reference range.

2. The transmission device as claimed in claim 1, wherein the digital signal processor is configured to calculate the correction coefficient for correcting the second distortion compensation coefficients based on the first distortion compensation coefficient reference range and the second distortion compensation coefficient reference range that are set based on the first and second amplified signals obtained by amplifying a training signal by the first amplifier and the second amplifier.

3. The transmission device as claimed in claim 1, further comprising:
a temperature monitoring circuit configured to detect temperatures,
wherein the digital signal processor is configured to calculate the correction coefficient for each of the temperatures detected by the temperature monitoring circuit.

4. The transmission device as claimed in claim 1, wherein the digital signal processor is configured to update the first distortion compensation coefficient reference range based on the second compensation coefficients corrected by the correction coefficient and perform distortion compensation on the input signal using the updated first distortion compensation coefficient reference range.

5. A transmission method performed by a transmission device including a first amplifier and a second amplifier, the method comprising:
calculating first distortion compensation coefficients based on a first amplified signal obtained by amplifying an input signal by the first amplifier,
setting a first distortion compensation coefficient reference range used to perform distortion compensation on the input signal based on power of the input signal and the first distortion compensation coefficients,
calculating second distortion compensation coefficients based on a second amplified signal obtained by amplifying the input signal by the second amplifier,
setting a second distortion compensation coefficient reference range used to perform distortion compensation on the input signal based on the power of the input signal and the second distortion compensation coefficients, and
calculating a correction coefficient for correcting the second compensation coefficients based on the first distortion compensation coefficient reference range and the second distortion compensation coefficient reference range.

6. A base station comprising the transmission device as claimed in claim 1.

7. The transmission device as claimed in claim 1, wherein at least one of the first amplifier and the second amplifier is a GaN device.

8. The transmission device as claimed in claim 1, wherein the first amplifier and the second amplifier have substantially a same drift characteristic.
